(19) United States
(12) Patent Application Publication
(10) Pub. No.: US 2023/0387387 A1
(43) Pub. Date: Nov. 30, 2023

(54) METHOD OF PRODUCING NEGATIVE ELECTRODE COMPOSITE MATERIAL SLURRY FOR NON-AQUEOUS ELECTROLYTE SECONDARY BATTERY

(71) Applicant: Prime Planet Energy & Solutions, Inc., Tokyo (JP)

(72) Inventors: Hideki SANO, Osaka (JP); Kouhei TSUZUKI, Kobe-shi (JP); Naoto ONODERA, Kobe-shi (JP); Yuki MORIKAWA, Kobe-shi (JP); Yurika KOJIMA, Kobe-shi (JP)

(21) Appl. No.: 18/320,202

(22) Filed: May 19, 2023

(30) Foreign Application Priority Data
May 27, 2022 (JP) 2022-086579

(51) Int. Cl. H01M 4/36; H01M 4/583; H01M 4/38; H01M 4/62

(52) U.S. Cl. CPC H01M 4/364; H01M 4/583; H01M 2004/027; H01M 4/622; H01M 4/386

(57) ABSTRACT

A method of producing a negative electrode composite material slurry for a non-aqueous electrolyte secondary battery comprises a first step to obtain a first mixed-kneaded body, and a second step to use the first mixed-kneaded body to obtain the negative electrode composite material slurry. The first step includes a step to mix and knead a negative electrode active material including a carbon-based active material and a Si-based active material, carboxymethylcellulose, polyacrylic acid, and water. The second step includes a step (x1) to mix and knead the first mixed-kneaded body, carboxymethylcellulose, and water. A solid content of the first mixed-kneaded body is from (a-3)% to a%, and a solid content of the negative electrode composite material slurry is from (a-15)% to (a-10)%. “a” refers to the solid content [%] defined in the specification.

This nonprovisional application is based on Japanese Patent Application No. 2022-086579 filed on May 27, 2022, with the Japan Patent Office, the entire contents of which are hereby incorporated by reference.

### BACKGROUND OF THE INVENTION

### Field of the Invention

The present invention relates to a method of producing a negative electrode composite material slurry for a non-aqueous electrolyte secondary battery.

### Description of the Background Art

In a non-aqueous electrolyte secondary battery (hereinafter also called “a battery”), for the purpose of enhancing battery capacity, a carbon-based active material and a Si-based active material may be used together as negative electrode active material in a negative electrode. It is known that a negative electrode including a Si-based active material expands and shrinks to a great extent during charge and discharge of the battery, readily leading to a decreased cycling performance of the battery. For example, International Patent Publication No. WO 2015/098050 discloses using polyacrylic acid as a binder to reduce expansion and shrinkage of Si-based active material to enhance cycling performance of the battery, and it also discloses additionally using carboxymethylcellulose as a binder to enhance storage stability of slurry composition which is used for forming a negative electrode.

### SUMMARY OF THE INVENTION

However, even when a carbon-based active material and a Si-based active material are used as negative electrode active material and polyacrylic acid and carboxymethylcellulose are used as binder, decrease of cycling performance and expansion of the electrode during charge and discharge of the battery may not be always reduced to a sufficient extent.

An object of the present disclosure is to provide a method of producing a negative electrode composite material slurry which has an excellent dispersibility of a negative electrode active material including a carbon-based active material and a Si-based active material, by which method a non-aqueous electrolyte secondary battery with reduced expansion of the electrode during charge and discharge and also with excellent cycling performance can be obtained.

The present disclosure provides a method of producing a negative electrode composite material slurry for a non-aqueous electrolyte secondary battery, and the method is described below.

[1] A method of producing a negative electrode composite material slurry for a non-aqueous electrolyte secondary battery, the method comprises:
a first step to obtain a first mixed-kneaded body; and
a second step to use the first mixed-kneaded body to obtain the negative electrode composite material slurry, wherein
the first step includes a step to mix and knead a negative electrode active material including a carbon-based active material and a Si-based active material, carboxymethylcellulose, polyacrylic acid, and water,
the second step includes a step (x1) to mix and knead the first mixed-kneaded body, carboxymethylcellulose, and water, and
when a solid content which is calculated based on a total weight of the negative electrode active material, carboxymethylcellulose, and polyacrylic acid included in the first mixed-kneaded body, as well as based on a weight of water included in the first mixed-kneaded body at a time when a torque equivalent to a 70% torque oil absorption number of the negative electrode active material is generated in the first mixed-kneaded body, is defined as a [%],
a solid content of the first mixed-kneaded body is from (a-3)% to a%, and
a solid content of the negative electrode composite material slurry is from (a-15)% to (a-10)%.

[2] The method of producing a negative electrode composite material slurry according to [1], wherein the carbon-based active material includes graphite.

[3] The method of producing a negative electrode composite material slurry according to [1] or [2], wherein the second step further includes a step (x2) to add a binder other than carboxymethylcellulose to a second mixed-kneaded body obtained by step (x1) and mix and knead together.

[4] The method of producing a negative electrode composite material slurry according to any one of [1] to [3], wherein step (x1) includes:
a step to mix carboxymethylcellulose with water to obtain a mixture; and
a step to mix and knead the first mixed-kneaded body with the mixture.

[5] The method of producing a negative electrode composite material slurry according to any one of [1] to [4], wherein a duration of mixing and kneading in the first step is 60 minutes or more.

[6] The method of producing a negative electrode composite material slurry according to any one of [1] to [5], wherein a duration of mixing and kneading in the second step is 10 minutes or more.

[7] The method of producing a negative electrode composite material slurry according to any one of [1] to [6], wherein a viscosity of a 1-weight % aqueous solution of the carboxymethylcellulose used in the first step is less than a viscosity of a 1-weight % aqueous solution of the carboxymethylcellulose mixed with the first mixed-kneaded body in the second step.

The foregoing and other objects, features, aspects and advantages of the present disclosure will become more apparent from the following detailed description of the present disclosure when taken in conjunction with the accompanying drawing.

### BRIEF DESCRIPTION OF THE DRAWING

FIG. 1 is a flowchart of a method of producing a negative electrode composite material slurry according to an embodiment.

### DESCRIPTION OF THE PREFERRED EMBODIMENTS

### Method of Producing Negative Electrode Composite Material Slurry for Non-Aqueous Electrolyte Secondary Battery

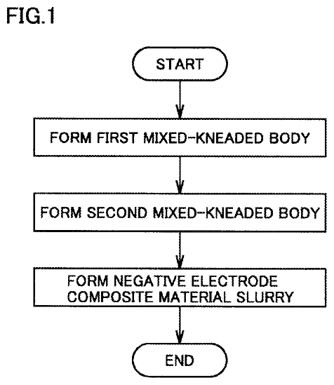

FIG. 1 is a flowchart of a method of producing a negative electrode composite material slurry according to an embodiment. The method of producing a negative electrode composite material slurry according to the present embodiment is a method of producing a negative electrode composite material slurry for a non-aqueous electrolyte secondary battery (hereinafter also called “the present battery”). The negative electrode composite material slurry is used for forming a negative electrode active material layer of a negative electrode of the present battery.

The negative electrode composite material slurry includes a negative electrode active material, a binder, and water. The negative electrode composite material slurry may further include fibrous carbon.

The negative electrode active material includes a carbon-based active material and a Si-based active material. When the negative electrode active material includes a carbon-based active material and a Si-based active material, as compared to when a carbon-based active material alone is used as the negative electrode active material, the battery capacity can be increased. Examples of the carbon-based active material include carbons (C) such as graphite, hard carbon, soft carbon, and amorphous-coated graphite. Examples of the Si-based active material include elemental silicon, Si-C composite (such as silicon nanoparticles dispersed in porous carbon particles), SiOx, and LixSiyOz.

The binder is preferably an aqueous binder that is soluble or dispersible in water. Examples of the binder include carboxymethylcellulose (hereinafter also called “CMC”), polyacrylic acid (hereinafter also called “PAA”), styrene-butadiene rubber (hereinafter also called “SBR”), polyethylene oxide (PEO), polyacrylonitrile (PAN), acrylonitrile butadiene rubber (NBR), and polytetrafluoroethylene (PTFE). Each of CMC and PAA may be either in acid form or in salt form. As the binder, the negative electrode composite material slurry may include at least CMC and PAA, and may further include SBR.

Examples of the fibrous carbon include carbon nanotubes (hereinafter also called “CNT”). The CNT may be single-walled carbon nanotubes (SWCNT), or may be multi-walled carbon nanotubes such as double-walled carbon tubes (DWCNT).

The method of producing a negative electrode composite material slurry includes a first step to obtain a first mixed-kneaded body, and a second step to use the first mixed-kneaded body to obtain the negative electrode composite material slurry. The first step includes a step to mix and knead the negative electrode active material, CMC, PAA, and water. The second step includes a step (x1) to mix and knead the first mixed-kneaded body, CMC, and water. The second step may further include a step (x2) to add a binder other than CMC to a second mixed-kneaded body obtained by step (x1) and mix and knead together.

When the solid content under the conditions described below is defined as a [%], the solid content of the first mixed-kneaded body obtained in the first step is from (a-3)% to a%. The step, in the first step, to mix and knead the negative electrode active material, CMC, PAA, and water is a step of high shear mixing, namely, a step of high-viscosity mixing and kneading. The above-described solid content of the first mixed-kneaded body may be from (a-2)% to a%, or may be from (a-1)% to a%, or may be not less than (a-1)% and less than a%. The solid content of the first mixed-kneaded body is calculated as the ratio [%] of the weight of solid matter (components other than water) to the weight (total weight) of the first mixed-kneaded body.

When the solid content under the conditions described below is defined as a [%], the solid content of the negative electrode composite material slurry obtained in the second step is from (a-15)% to (a-10)%. The second step is carried out for adjusting the solid concentration of the negative electrode composite material slurry. The above-described solid content of the negative electrode composite material slurry may be from (a-14)% to (a-10)%, or may be from (a-14)% to (a-11)%, or may be from (a-13)% to (a-11)%. The solid content of the negative electrode composite material slurry is calculated as the ratio [%] of the weight of solid matter (components other than water) to the weight (total weight) of the negative electrode composite material slurry. For example, the solid content, a [%], is from 60% to 75%.

The solid content, a [%], is calculated (by the below equation) based on the total weight, M1, of the negative electrode active material, CMC, and PAA included in the first mixed-kneaded body, as well as based on the weight of water, M2, included in the first mixed-kneaded body at the time when a torque equivalent to a 70% torque oil absorption number of the negative electrode active material is generated in the first mixed-kneaded body.

a [%]={M1/(M1+M2)}×100

The 70% torque oil absorption number of the negative electrode active material is a 70% torque oil absorption number of the negative electrode active material (the carbon-based active material and the Si-based active material) included in the first mixed-kneaded body. The 70% torque oil absorption number of the negative electrode active material is the oil absorption number of the negative electrode active material when the torque generated at that point in time is 70% relative to the maximum torque (100% torque) observed while the change of viscosity properties is being measured and recorded with a torque detector during constant-rate dropwise addition of linseed oil into the negative electrode active material included in the first mixed-kneaded body.

The Si-based active material expands and shrinks to a great extent during charge and discharge of the battery, and, as a result, conductive paths formed between the Si-based active material and the neighboring negative electrode active material (the carbon-based active material or the Si-based active material) are likely to be cut off. When, in the first step, the mixing and kneading of the negative electrode active material, CMC, PAA, and water is carried out in a manner that the solid content of the first mixed-kneaded body falls within the range described above, it is possible to make PAA function well enough to reduce cutting-off of conductive paths of the Si-based active material that can occur during charge and discharge of the present battery. In addition, performing the first step can reduce expansion of the cell during repeated charge and discharge of the present battery, leading to reduced reaction force of the cell as well as reduced packaging cost for the present battery.

As compared to the carbon-based active material, the Si-based active material produces more SEI (Solid Electrolyte Interphase) on its surface during charge and discharge of the battery, and tends to cause a decrease of battery capacity (cycling performance of the battery) during charge and discharge. When, in the first step, the mixing and kneading of the negative electrode active material, CMC, PAA, and water is carried out in a manner that the solid content of the first mixed-kneaded body falls within the range described above, it is possible to make CMC adhere to the surface of the negative electrode active material, leading to an appropriate level of decrease of electrochemically active surface (hereinafter also called “an active surface”) of the negative electrode active material. By this, the amount of SEI produced during charge and discharge of the present battery can be adjusted to fall within an appropriate range, leading to an inhibited decrease of cycling performance of the present battery.

However, when CMC added in the first step is used for reducing the active surface of the negative electrode active material, less CMC is left to function for inhibiting sedimentation of the negative electrode active material in the negative electrode composite material slurry. To prevent this, in the second step, CMC and water are added to the first mixed-kneaded body and mixed and kneaded (step (x1)). By this, sedimentation of the negative electrode active material in step (x1) of the second step can be inhibited, giving a negative electrode composite material slurry with excellent dispersibility of the negative electrode active material. In addition, when the solid content of the negative electrode composite material slurry obtained in the second step is adjusted to fall within the range described above, a negative electrode composite material slurry can be obtained whose viscosity is easy to apply to a negative electrode current collector at the time of negative electrode production.

As described above, in the method of producing a negative electrode composite material slurry, the total amount of CMC is split into portions, one to be added and mixed and kneaded in the first step, and the other to be added and mixed and kneaded in the second step. As a result, CMC can be used for adjusting the active surface of the negative electrode active material in the first step, and CMC can also be used for adjusting the dispersibility of the negative electrode active material in the negative electrode composite material slurry in the second step. If CMC is added in the first step but not in the second step, the active surface of the negative electrode active material can be adjusted and therefore a decrease of cycling performance of the battery tends to be inhibited, but sedimentation of the negative electrode active material in the negative electrode composite material slurry tends not to be inhibited. If CMC is not added in the first step and is added in the second step, sedimentation of the negative electrode active material in the negative electrode composite material slurry tends to be inhibited, but the active surface of the negative electrode active material cannot be adjusted and, as a result, a decrease of cycling performance of the battery tends not to be inhibited.

In the first step, the first mixed-kneaded body may be obtained by mixing and kneading the negative electrode active material, CMC, PAA, and water. Alternatively, in the first step, the first mixed-kneaded body may be obtained by firstly mixing the negative electrode active material, CMC, and PAA to obtain a mixture (such as a mixed powder, for example) and then adding water to the mixture and mixing and kneading together.

The duration of mixing and kneading in the first step is preferably 60 minutes or more, optionally 90 minutes or more, optionally 120 minutes or more, preferably 180 minutes or more. The duration of mixing and kneading in the first step is usually 300 minutes or less, optionally 240 minutes or less. When the duration of mixing and kneading in the first step is within the range described above, the active surface of the negative electrode active material can be decreased as appropriate, and, as a result, a decrease of battery capacity during charge and discharge of the present battery tends to be further inhibited. In addition, when the duration of mixing and kneading in the first step is within the range described above, cutting-off of conductive paths of the Si-based active material during charge and discharge of the present battery tends to be further inhibited.

The second step may not necessarily include step (x2) as long as it includes step (x1), but, preferably, it includes both step (x1) and step (x2). In step (x1), the second mixed-kneaded body may be obtained by mixing and kneading the first mixed-kneaded body, CMC, and water, but, preferably, the second mixed-kneaded body is obtained by firstly mixing CMC with water to obtain a mixture (such as an aqueous CMC solution, for example) and then mixing and kneading the mixture with the first mixed-kneaded body. In the second step, the second mixed-kneaded body thus obtained may be used as it is as the negative electrode composite material slurry, or, alternatively, the negative electrode composite material slurry may be obtained by performing step (x2) to add a binder other than CMC to the second mixed-kneaded body obtained in step (x1) and mix and knead together.

The binder other than CMC added in step (x2) is preferably a binder other than CMC or PAA, and, more preferably, it is SBR.

The duration of mixing and kneading in the second step is preferably 10 minutes or more, optionally 15 minutes or more, optionally 20 minutes or more. Although the duration of mixing and kneading in the second step is not particularly limited, it is usually 120 minutes or less, optionally 60 minutes or less, from the productivity viewpoint. When the second step includes step (x1) and step (x2), the duration of mixing and kneading in the second step is the sum of the duration of mixing and kneading in step (x1) and that in step (x2). When the duration of mixing and kneading in the second step is within the range described above, a negative electrode composite material slurry having excellent dispersibility of the negative electrode active material tends to be obtained.

The viscosity, V1, of a 1-weight % aqueous solution of the CMC used in the first step is preferably less than the viscosity, V2, of a 1-weight % aqueous solution of the CMC mixed with the first mixed-kneaded body in the second step. Each of viscosity V1 and viscosity V2 is a viscosity at a temperature of 25° C. For example, viscosity V1 at a temperature of 25° C. may be from 1000 mPa·s to 5000 mPa·s, or may be from 1500 mPa·s to 4000 mPa·s, or may be from 1500 mPa·s to 2000 mPa·s, or may be from 2000 mPa·s to 3000 mPa·s. For example, viscosity V2 at a temperature of 25° C. may be from 2000 mPa·s to 9000 mPa·s, or may be from 3000 mPa·s to 8000 mPa·s, or may be from 300 mPa·s to 4000 mPa·s, or may be from 6000 mPa·s to 8000 mPa·s. Each of viscosities V1 and V2 of 1-weight % aqueous solution of CMC can be measured by the procedure described below in the Examples section.

The fibrous carbon that may be included in the negative electrode composite material slurry may be added either in the first step at the time of obtaining the first mixed-kneaded body, or in the second step at the time of obtaining the negative electrode composite material slurry, or both. When fibrous carbon is added in the second step, it may be added either in step (x1) or in step (x2), or both.

The viscosity of the negative electrode composite material slurry at a temperature of 25° C. may be from 50 Pa·s to 270 Pa·s, or may be from 100 Pa·s to 250 Pa·s, or may be from 120 Pa·s to 200 Pa·s. The viscosity of the negative electrode composite material slurry can be measured by the procedure described below in the Examples section.

### Non-Aqueous Electrolyte Secondary Battery

In the present battery, the negative electrode active material layer of the negative electrode faces a positive electrode active material layer of a positive electrode, with a separator and an electrolyte interposed between them. The negative electrode, the positive electrode, and the separator configure an electrode of the present battery. The present battery may include, for example, an exterior package for accommodating the electrode and the electrolyte.

The negative electrode usually has a negative electrode current collector and a negative electrode active material layer. The negative electrode current collector is, for example, a metal foil made of a copper material such as copper and copper alloy. The negative electrode active material layer can be obtained by applying the above-described negative electrode composite material slurry to the negative electrode current collector, followed by drying and compressing.

The positive electrode usually has a positive electrode current collector and a positive electrode active material layer, and the positive electrode current collector is, for example, a metal foil made of an aluminum material such as aluminum and aluminum alloy. For the positive electrode active material layer, any material that is known in the field to which the present battery pertains can be used.

For the separator and the electrolyte, any material that is known in the field to which the present battery pertains can be used.

### EXAMPLES

In the following, the present disclosure will be described in further detail by way of Examples and Comparative Examples.

### Preparation of CMC

The following CMCs were prepared.

BSH-3;

Viscosity of 1-weight % aqueous solution at 25° C.: 1500 to 2000 mPa·s

Degree of etherification: 0.65 to 0.75

BSH-6;

Viscosity of 1-weight % aqueous solution at 25° C.: 3000 to 4000 mPa·s

Degree of etherification: 0.65 to 0.75

BSH-12;

Viscosity of 1-weight % aqueous solution at 25° C.: 6000 to 8000 mPa·s

Degree of etherification: 0.65 to 0.75

### Comparative Example 1

To a mixture of 87 parts by weight of graphite as a carbon-based active material, 10 parts by weight of a Si-C composite as a Si-based active material, 1 part by weight of CMC (BSH-6, powder) as a binder, and 1 part by weight of PAA (powder) as a binder, 53 parts by weight of water (the amounts were relative to 100 parts by weight of the negative electrode active material (the carbon-based active material and the Si-based active material)) was added, and mixed and kneaded together in a planetary mixer for 30 minutes, and thereby a first mixed-kneaded body was obtained (first step). Then, while 34 parts by weight (relative to 100 parts by weight of the negative electrode active material) of water was being added thereto by a small amount at a time, the resulting first mixed-kneaded body was mixed and kneaded for 20 minutes, and thereby a second mixed-kneaded body was obtained (second step). To the resulting second mixed-kneaded body, 1 part by weight of SBR as a binder was added, and mixed and kneaded together for 5 minutes, and thereby a negative electrode composite material slurry was obtained (second step). The solid content a, as well as the solid contents of the first mixed-kneaded body and the negative electrode composite material slurry, are shown in Table 1.

### Comparative Example 2

A negative electrode composite material slurry was obtained in the same manner as in Comparative Example 1 except that the duration of mixing and kneading at the time of obtaining the first mixed-kneaded body was changed to 180 minutes. The solid content a, as well as the solid contents of the first mixed-kneaded body and the negative electrode composite material slurry, are shown in Table 1.

### Example 1

A negative electrode composite material slurry was obtained in the same manner as in Comparative Example 2 except that the amount of CMC used at the time of obtaining the first mixed-kneaded body was changed to 0.5 parts by weight, and that 34 parts by weight of water used at the time of obtaining the second mixed-kneaded body (the amounts were relative to 100 parts by weight of the negative electrode active material) was changed to 34 parts by weight of a 1.5-weight % aqueous solution of CMC (BSH-6, powder). The solid content a, as well as the solid contents of the first mixed-kneaded body and the negative electrode composite material slurry, are shown in Table 1.

### Example 2

A negative electrode composite material slurry was obtained in the same manner as in Example 1 except that 0.5 parts by weight of CMC used at the time of obtaining the first mixed-kneaded body was changed to 0.7 parts by weight of CMC (BSH-3, powder), and that 34 parts by weight of the 1.5-weight % aqueous solution of CMC used at the time of obtaining the second mixed-kneaded body was changed to 34 parts by weight of a 0.9-weight % aqueous solution of CMC (BSH-12, powder) (the amounts were relative to 100 parts by weight of the negative electrode active material). The solid content a, as well as the solid contents of the first mixed-kneaded body and the negative electrode composite material slurry, are shown in Table 1.

### Comparative Example 3

87 parts by weight of graphite as a carbon-based active material, 10 parts by weight of a Si-C composite as a Si-based active material, 1 part by weight of CMC (BSH-6, powder) as a binder, 1 part by weight of PAA (powder) as a binder, and 76 parts by weight of water (the amounts were relative to 100 parts by weight of the negative electrode active material) were mixed and knead in a planetary mixer for 180 minutes, and thereby a first mixed-kneaded body was obtained (first step). Then, to the resulting first mixed-kneaded body, 1 part by weight of SBR as a binder was added, and mixed and kneaded together for 10 minutes, and thereby a negative electrode composite material slurry was obtained (second step). The solid content a, as well as the solid contents of the first mixed-kneaded body and the negative electrode composite material slurry, are shown in Table 1.

### Calculation of Solid Content

### Calculation of Solid Content a

Into the negative electrode active material (the carbon-based active material and the Si-based active material) included in the first mixed-kneaded body, linseed oil was added dropwise at a constant rate. The maximum torque generated during measuring and recording the change of viscosity properties of the negative electrode active material (into which linseed oil was added dropwise) with a torque detector (S-500, manufactured by ASAHI SOUKEN) was defined as 100% torque. The oil absorption number at the time when 70% torque, with respect to the 100% torque, was generated was determined as a 70% torque oil absorption number. The 70% torque oil absorption number of graphite as the carbon-based active material and that of the Si-C composite as the Si-based active material were measured in the same manner as described above, and, as a result, the 70% torque oil absorption number of graphite was 48 ml/100 g and the 70% torque oil absorption number of the Si-C composite was 77 ml/100 g.

The weight of water, M2, included in the first mixed-kneaded body at the time when a torque equivalent to the 70% torque oil absorption number determined above was generated in the first mixed-kneaded body was determined. Based on the total weight. M1, of the negative electrode active material and the binder (CMC and PAA) included in the first mixed-kneaded body, as well as based on the above-determined weight of water, M2, the solid content a was calculated.

### Viscosity Measurement

### Viscosity of Negative Electrode Composite Material Slurry

The viscosity of the negative electrode composite material slurry was measured with the use of a measurement apparatus which is to be described below, under the conditions described below, as a viscosity [Pa·s] at a shear rate of 0.01 sec⁻¹ at a temperature of 25° C.

Measurement apparatus: MCR102 (manufactured by Anton Paar)

Conditions: cone and plate, flow curve measurement

### Viscosity of Aqueous CMC Solution

The viscosity of the aqueous CMC solution (viscosity of the 1-weight % aqueous solution at a temperature of 25° C.) was measured with the use of a BM-type viscometer.

### Calculation of Solid Content of First Mixed-Kneaded Body

It was calculated as the ratio [%] of the weight of solid matter (the negative electrode active material and the binder, other than water) to the weight of the first mixed-kneaded body (the total amount of the negative electrode active material, the binder, and water).

### Calculation of Solid Content of Negative Electrode Composite Material Slurry

It was calculated as the ratio [%] of the weight of solid matter (the negative electrode active material and the binder, other than water) to the weight of the negative electrode composite material slurry (the total amount of the negative electrode active material, the binder, and water).

### Evaluation of Capacity Retention and Cell Thickness Increment

### Fabrication of Battery

The negative electrode composite material slurry obtained in Examples and Comparative Examples was applied to a negative electrode current collector, followed by drying and compressing, to form a negative electrode active material, and thereby a negative electrode was obtained, which was used to fabricate a non-aqueous electrolyte secondary battery. The specifications of the cell were as follows: the exterior package was of laminate type, the electrode was of stack type, and the capacity was designed to be 700 mAh.

### Calculation of Capacity Retention

The battery thus fabricated was subjected to cycle testing of 50 cycles of charge and discharge. The capacity after one cycle and the capacity after 50 cycles were measured, and capacity retention was calculated by the equation below. Results are shown in Table 1.

Capacity retention [%]=((capacity after 50 cycles)/(capacity after one cycle))×100

### Calculation of Cell Thickness Increment

The battery thus fabricated was subjected to cycle testing of 300 cycles of charge and discharge. The cell thickness after one cycle and the cell thickness after 300 cycles were measured, and cell thickness increment was calculated by the equation below. Results are shown in Table 1.

Cell thickness increment [%]={((Cell thickness after 300 cycles)/(cell thickness after one cycle))−1}×100

TABLE 1

| | Comp. | Comp. | | | Comp. |
|---|---|---|---|---|---|
| | Ex. | Ex. | Ex. | Ex. | Ex. |
| | 1 | 2 | 1 | 2 | 3 |
| First step | | | | | |
| Duration of mixing and | 30 | 180 | 180 | 180 | 180 |
| kneading [min] | | | | | |
| Type of CMC | BSH-6 | BSH-6 | BSH-6 | BSH-3 | BSH-6 |
| State of added CMC | Powder | Powder | Powder | Powder | Powder |
| Second step | | | | | |
| Duration of mixing | 25 | 25 | 25 | 25 | — |
| and kneading [min] | | | | | |
| Type of CMC | — | — | BSH 6 | BSH 12 | — |
| State of added CMC | — | — | Aqueous | Aqueous | — |
| | | | solution | solution | |
| Solid content a [%] | 66.5 | 66.5 | 66.5 | 66.5 | 66.5 |
| Solid content [%] of | 65.8 | 65.8 | 65.7 | 65.7 | 57.3 |
| first mixed-kneaded | | | | | |
| body | | | | | |
| Solid content [%] of | 53.8 | 53.8 | 53.9 | 53.9 | 57.1 |
| negative electrode | | | | | |
| composite | | | | | |
| material slurry | | | | | |
| Viscosity [Pa · s] of | 283 | 26 | 190 | 163 | 325 |
| negative electrode | | | | | |
| composite | | | | | |
| material slurry | | | | | |
| Evaluation | | | | | |
| Capacity retention [%] | 93 | 97 | 97 | 97 | 91 |
| Cell thickness | 4.5 | 2.2 | 3.9 | 3.2 | 7.2 |
| increment [%] | | | | | |

In Comparative Example 1 where the duration of mixing and kneading in the first step is short and no CMC is added in the second step, capacity retention of the battery is low as compared to Examples 1 and 2, indicating that a decrease of cycling performance of the battery is not sufficiently inhibited. In Comparative Example 2 where no CMC is added in the second step, the viscosity of the negative electrode composite material slurry is low as compared to Examples 1 and 2, indicating the occurrence of sedimentation of the negative electrode active material in the negative electrode composite material slurry. In Comparative Example 3 where the solid content of the first mixed-kneaded body is low, high shear mixing is not performed in the first step, and CMC addition and mixing and kneading together is not performed in the second step, capacity retention of the battery is low and cell thickness increment is high as compared to Examples 1 and 2. As a result, it seems that, in the battery of Comparative Example 3, a decrease of cycling performance of the battery cannot be sufficiently inhibited, cell reaction force is high, and packaging cost reduction for the present battery tends not to be achieved.

The embodiments and Examples disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A method of producing a negative electrode composite material slurry for a non-aqueous electrolyte secondary battery, the method comprises:
a first step to obtain a first mixed-kneaded body; and
a second step to use the first mixed-kneaded body to obtain the negative electrode composite material slurry, wherein
the first step includes a step to mix and knead a negative electrode active material including a carbon-based active material and a Si-based active material, carboxymethylcellulose, polyacrylic acid, and water,
the second step includes a step (x1) to mix and knead the first mixed-kneaded body, carboxymethylcellulose, and water, and
when a solid content which is calculated based on a total weight of the negative electrode active material, carboxymethylcellulose, and polyacrylic acid included in the first mixed-kneaded body, as well as based on a weight of water included in the first mixed-kneaded body at a time when a torque equivalent to a 70% torque oil absorption number of the negative electrode active material is generated in the first mixed-kneaded body, is defined as a [%],
a solid content of the first mixed-kneaded body is from (a-3)% to a%, and
a solid content of the negative electrode composite material slurry is from (a-15)% to (a-10)%.

2. The method of producing a negative electrode composite material slurry according to claim 1, wherein the carbon-based active material includes graphite.

3. The method of producing a negative electrode composite material slurry according to claim 1, wherein the second step further includes a step (x2) to add a binder other than carboxymethylcellulose to a second mixed-kneaded body obtained by step (x1) and mix and knead together.

4. The method of producing a negative electrode composite material slurry according to claim 1, wherein step (x1) includes:
a step to mix carboxymethylcellulose with water to obtain a mixture; and
a step to mix and knead the first mixed-kneaded body with the mixture.

5. The method of producing a negative electrode composite material slurry according to claim 1, wherein a duration of mixing and kneading in the first step is 60 minutes or more.

6. The method of producing a negative electrode composite material slurry according to claim 1, wherein a duration of mixing and kneading in the second step is 10 minutes or more.

7. The method of producing a negative electrode composite material slurry according to claim 1, wherein a viscosity of a 1-weight % aqueous solution of the carboxymethylcellulose used in the first step is less than a viscosity of a 1-weight % aqueous solution of the carboxymethylcellulose mixed with the first mixed-kneaded body in the second step.
